(19) United States
(12) Patent Application Publication
(10) Pub. No.: US 2015/0310353 A1
(43) Pub. Date: Oct. 29, 2015

(54) Optimized Peremptory Juror Challenges

(71) Applicants: David Merril Caditz, Sausalito, CA (US); Michael Robert Caditz, Santa Fe, NM (US)

(72) Inventors: David Merril Caditz, Sausalito, CA (US); Michael Robert Caditz, Santa Fe, NM (US)

(21) Appl. No.: 14/261,049

(22) Filed: Apr. 24, 2014

(51) Int. Cl. G06Q 10/00; G06Q 50/26; G06Q 50/18

(52) U.S. Cl. CPC G06Q 10/00; G06Q 50/18; G06Q 50/26

(57) ABSTRACT

The present invention teaches methods to optimize the exercise of peremptory challenges during the jury selection process in courts in the United States and worldwide. Jury selection in such jurisdictions is governed by possibly complex rules determined by the court, including procedures and specifications for the order of juror examinations and the subsequent exercise of peremptory challenges. Such peremptory challenges are typically limited in number and are therefore valuable to parties in a court action. Prior art uses ‘gut feeling’, intuition and educated guessing to guide in the exercise of peremptory challenges and is therefore not likely to produce an optimally empaneled jury. The present invention optimizes the use of challenges for the user of the invention by applying the results of Game Theory—a branch of mathematics focusing on competitive interactions between two or more parties, each with potentially conflicting interests over a common outcome. The current invention also provides a means to make such an optimization practical within a real world courtroom setting where decisions may be required in quick succession with little time for deliberation. The current invention can also be applied to similar selection situations such as a search committee's decision to select one or more applicants for a job, selecting applicants for admission to a college or research group, selection of corporate officers, sports team draft procedures, and numerous other situations wherein a group or committee composed of members with potentially conflicting interests must make selections from among a pool of applicants with possibly limited information about applicant favorability.

### CROSS-REFERENCE TO RELATED APPLICATIONS

| Application | | Inventor | |
|---|---|---|---|
| No. | Filing Date | Name | Relationship |
| 8,515,790 | Aug. 20, 2013 | Griebat | Organizational software |
| 6,607,389 | Aug. 19, 2003 | Genevie | Mock trial |
| 6,640,213 | Oct. 28, 2003 | Carp, et al. | Organizational software |
| 6,895,398 | May 17, 2005 | Evans- | Bayesian decision making |
| | | Beauchamp, | to assist in juror rating |
| | | et. al. | |
| 20100235217 | Sep. 16, 2010 | Ehlert, et al. | Organizational software |
| 20100169106 | Jul. 1, 2010 | Powers, et al. | System for profiling jurors |
| 20060212341 | Sep. 21, 2006 | Powers | Set-based model for |
| | | | challenge |
| | | | recommendations. |
| 20060198502 | Sep. 7, 2006 | Griebert | System for profiling jurors |
| 20110131053 | Jun. 2, 2011 | Reymond, | Organizational software |
| | | et. al | |
| 20040054546 | Mar. 18, 2004 | Levin, et al. | Organizational software |
| 20040024634 | Feb. 5, 2004 | Carp, et al. | Organizational software- |
| | | | automated voir dire |
| 20030031991 | Feb. 13, 2003 | Genevie | Mock trial |
| 20040002044 | Jan. 1, 2004 | Genevie | Mock trial |

### OTHER REFERENCES

Roth, et. al., “Optimal Peremptory Challenges in Trials by Juries: A Bilaterial Sequential Process” (1977), Carnegie Mellon University, Dietrich College of Humanities and Social Sciences, Department of Statistics, Paper 42. http://repository.cmu.edu/statistics/42/

### BACKGROUND OF THE INVENTION

This invention pertains to methods for selection of jury members currently in use in court systems in the United States and worldwide. Most such jurisdictions provide litigants the opportunity to challenge and strike potential jury members, for cause or peremptorily, with the goal of making the final empaneled jury a fair representation of the population, reducing pre-existing bias, and making the empanelled jury generally agreeable to all parties. The current invention functions to optimize the use of peremptory challenges for a litigant in order to obtain a most favorable empaneled jury.

While systems for challenging potential jury members vary among jurisdictions, two such systems—the so-called ‘Sequential’ (or ‘Strike and Replace’) and ‘Struck’ systems—are in common use. Such systems provide for a juror examination for obtaining information about the backgrounds and attitudes of potential jury members. The examination process typically includes written jury questionnaires, written and verbal responses to questions presented by the Judge, or written and verbal responses to questions presented by the opposing attorneys. Such ‘voir dire’ examinations can provide detailed information about jurors on which litigating parties can base their juror ratings. Litigants are then provided the opportunity to challenge potential jurors based on their voir dire ratings and other information gained during the selection process, such as demographic information or juror behavior. Peremptory challenges are typically limited in number, and each such challenge is therefore valuable to each litigant. The exercise of a peremptory challenge against a particular potential juror is an important decision which should be made strategically by each litigant and which may have important consequences for the outcome of the trial.

Jurisdictions may differ in the systems or processes for peremptory challenges, including when in the process voir dire examinations are made and when challenges may be exercised. The Sequential and Struck systems differ in the timing under which jurors are examined, challenged and replaced. In the Sequential method, potential jurors are examined individually or in small groups. One party is given the opportunity to examine the juror(s) and exercise peremptory challenges. If a juror is challenged, a replacement juror is seated and the examination continues. Once the first party is satisfied with the seated juror (or has no remaining peremptory challenges), the second party begins the same process of examination, challenge and replacement. After the second party accepts a juror (or has no remaining peremptory challenges), that juror becomes a member of the jury and the process is repeated for the next potential juror. The Sequential process continues until no party can, or desires to, challenge a juror, and a jury of the correct size is seated.

The sequential method can be further divided into two systems which differ in the way replacement jurors are selected after a juror is challenged. The Unordered Sequential system selects replacement jurors at random from a jury pool, while the Ordered Sequential system selects replacement jurors in order from a jury pool. A litigant exercising a challenge under the Unordered System must assume that the value of a replacement juror will be the expected value of the statistical distribution of values among the jury pool. In contrast, the Ordered Sequential system provides litigants with more information about replacement jurors as the identities of the replacements are known before the challenge is exercised.

In the Struck method, a panel of potential jurors, greater than or equal in size to the required size of the final jury plus the number of allowed peremptory challenges, is seated. Voir Dire is then conducted against this seated panel. The parties then exercise their allotted peremptory challenges and the members remaining after all challenges are exercised (or a selection of the remaining members, should not all challenges be exercised) are empanelled. The Struck system therefore provides litigants with all available information about all potential jurors before any challenges are exercised. All litigants, therefore, make decisions based on a complete and common set of information. In addition, the Struck system allows litigants to observe the opposing party's voir dire examinations, thereby giving some indication as to which jurors the various parties are focusing on and which jurors they may find favorable or unfavorable.

Additional variations in the application of these methods may exist between venues, court houses or court rooms, however, for the purposes of the present invention, the main factor differentiating the Sequential and Struck systems is the degree to which information is known about jurors and their potential replacements at the time that a decision is made to exercise a peremptory challenge. In the Sequential system, a party has little or no information about jurors not currently under consideration for challenge. In addition, because the first party must make a decision to strike after his examination of a juror, he does not have the benefit of any information that might be gained during the examination of the juror by a subsequent party. A subsequent party, on the other hand, has the advantage of basing its decision on information gained during earlier examinations by other parties. The Struck system, on the other hand, allows all parties to base their decisions upon complete and common information gained prior to the exercise of any peremptory challenges.

Further challenges arise in real world situations where strict time constraints may be placed on litigants for the exercise of peremptory challenges. It is not uncommon for litigants to be allowed only minutes to make challenge decisions for an entire juror panel of 20 or more members. Complicating this is that each litigant may be represented by one or more agents who may have differing opinions as to the value of a given juror. For example, a litigant may be represented by a team of lawyers and trial consultants who must reach a consensus on the exercise of peremptory challenges within minutes. Such practical issues often preclude the systematic application of theoretically advanced analytical decision making tools in a courtroom setting, relegating important decisions to the level of guesswork, hunches, gut feeling and rushed negotiation between a litigant's various agents.

A handful of computer software programs have been offered which allow litigants to track information about jurors, provide means for entering juror ratings, provide methods to select jurors remotely or in venues outside of the courtroom, or facilitate the jury selection process in general (U.S. Pat. No. 8,515,790, U.S. Pat. No. 6,640,213, 20100235217, 20060198502, 20040054546, 20040024634). However, to our knowledge, all such methods are primarily organizational in nature and stop short of providing methods to recommend the exercise of peremptory challenges based on the entered information. As such, these prior software programs are limited in use as organizational tools, and litigants using these programs must still rely on guesswork to make peremptory challenges. Additionally, most such prior software programs are limited in the scope of the information that can be tracked, do not provide for a more than two litigants, do not provide for multiple agents per litigant, do not allow multiple rating scales, do not provide a networked environment for use by multiple simultaneous users, and are generally cumbersome to use in a courtroom setting.

A second class of patents teaches methods to assist in rating jurors including methods for conducting mock trials (U.S. Pat. No. 6,607,389, 20030031991, 20040002044) and demographic-based decision making (U.S. Pat. No. 6,895,398, 20100169106, 20060212341).

A single patent application (20100235217) teaches a method to make peremptory challenge recommendations based upon a partitioned rank order model. This model involves the partitioning of the jury pool into sets. The user then allocates a portion of their available peremptory challenges to a given set based on, for example, the size of the set relative to the total number of mathematically eligible jurors. Challenges are then recommended against the least favorable jurors in a given set equal in number to the number of peremptory challenges allocated to that set. The model apparently applies to jury selection systems wherein jury members undergo voir dire in groups or panels, new panels being seated and examined when required to complete the jury. One currently available software product is based on this model (http://juryguru.com/). This model does not include jury optimization through game theoretic principles, as does the current invention. It does appear to apply to Ordered or Unordered Sequential Systems wherein jurors are examined one-by-one, or to a non-zero sum Struck system where challenging the lowest rated jurors may not be the optimal strategy. Neither does it make use of rating ranges nor rating distributions as does the current invention. In addition, there is no prima facie reason why such a partitioning system would be expected to mathematically optimize the use of peremptory challenges, even in the applicable systems, since, for example, different juror sets may have different overall favorability characteristics and/or the ratio of set sizes could be fractional.

A paper by Roth, et. al., 1977 applies game theoretic principles to jury selection under the limited conditions of a two party unordered sequential system where jurors are examined individually and where each party knows the ratings placed on jurors and on the jury pool by both parties. This paper does not discuss any methods or apparatus for organizing and tracking any aspects of the jury selection process, not does it address struck systems, ordered sequential systems or any systems where jurors are examined in groups. Furthermore, the results are apparently not correct for juries of size N>1.

The decision by a litigant to challenge a juror is ultimately based on whether doing so will result in the final empaneled jury being most favorable to that litigant. The choice is not always obvious, even when the favorability, or ranking, of each individual juror is known. For example, if a jurisdiction uses a Sequential system, challenging a particular unfavorable juror may preclude the litigant from challenging an even less favorable juror later in the selection process, due to exhaustion of requests. To make best possible use of the limited number of peremptory challenges, a litigant must choose a strategy that will optimize the favorability of the final empaneled jury, taking account of the favorability of each individual juror, the favorability of potential replacement jurors, the characteristics of the jury pool, the process used for juror strikes, and an understanding of the opposing litigant's challenge strategy. Given the complexities involved, an optimal challenge strategy may not be apparent to a litigant or practical to determine in a courtroom setting. A need therefore exists for a tool that can assist a litigant in managing the jury selection process and, in particular, assist in the selection of a challenge strategy that will help determine at each decision point of the jury empanelment process whether or not challenging a particular juror is most likely to lead to a more favorable final jury outcome. The present invention provides this tool.

### SUMMARY OF THE INVENTION

Optimization of the outcome of an interaction between two or more parties under a process governed by a well-defined set of rules is addressed by a branch of mathematics known as Game Theory. The current invention teaches methods to apply Game Theory to the process of jury empanelment in order to obtain a result that optimizes the favorability of an empanelled jury for a given litigant. The specific application of such game theoretic principles and algorithms depends upon the rules and procedures for jury empanelment in the particular jurisdiction or courtroom in question. The present invention describes a process and an apparatus by which game theoretic principles can be applied to any jury empanelment procedure, including features by which input is accepted from a user in order to determine the best algorithms to apply, features to enter, store view and modify and share juror ratings, features to combine such ratings, and features to calculate recommendations for exercising optimal peremptory challenges.

Generally speaking, game theoretic principles and algorithms involve the specification of sets of ‘pure’ strategies which in the present invention means sets of choices to challenge or accept particular jurors. Such pure strategies are defined for all parties involved in the litigation and combined into a table called a ‘Game Matrix’. The Game Matrix represents all possible strategy combinations among all parties, as well as the outcomes for each such strategy combination. Based on said outcomes, a party can then choose their most favorable strategy.

A second, and mathematically equivalent method to apply game theory is to construct a ‘Game Tree’. A Game tree contains ‘nodes’ representing states of play, and edges connecting said nodes representing choices (challenge or accept) made by the party in control of the node (the party making the present challenge decision). Every node contains information regarding the state of the process after a given number of challenge and accept choices have been made. The first, or ‘root’, node represents the beginning state wherein no choices have been made. The last nodes in the tree, called leaf nodes, represent possible final states after all challenges have been exhausted (or left unused). Every non-leaf node is connected by an ‘accept’ edge to a child node which represents the state of the process after a juror has been accepted (not challenged) by the controlling party. If the controlling party has one or more remaining challenges, then a non-leaf node is also connected by a ‘challenge’ edge to a child node represent the state of the process upon exercising a challenge. In this way, a tree is constructed, starting with the juror presently under consideration, each branch ending when all challenges have been exhausted (or left unused). Said tree enumerates all possible states and outcomes of the selection process and guides the user of the current invention as to their best choice at each decision point. Generally, parties alternate control of nodes, meaning that after a party makes a choice at a given node, an opposing party is given control of the subsequent node. Such node control alternation is the default process for the current invention. However, a setting is provided to override this default process, allowing a tree to be constructed according to any rule for node control, such as, for example, defense always chooses first or a challenging party makes the next choice on the replacement juror.

A preferred embodiment uses computer software to generate Game Theory matrix or Game Tree in order to assist a litigant in making a choice between challenge and no-challenge at each decision point in a jury empanelment process. The software accounts for all known information up to the current decision point, including the favorability rating of each potential juror, the statistical distribution of favorability ratings of the jury pool as a whole, the rules and procedures of jury empanelment process, the number of remaining peremptory challenges for each litigant, and the opposing litigants' juror selection strategy. The software then applies the principles of Game Theory to recommend at each decision point whether or whether not challenging a particular juror will most likely lead to a jury empanelment most favorable to the user. The choice of algorithm, Game Matrix or Game Tree, depends upon the rules and procedures for jury empanelment used in a particular courtroom, as described below.

Rules and Procedures of Jury Empanelment: The rules and procedures for jury empanelment used by a court are entered into the current invention during an initial setup process. The current invention provides a user interface (UI) for entering such rules and initial setup data. This UI is modular such that templates can be chosen that correspond with, and are optimized for, the jury empanelment system used in the present courtroom. Such UI templates include those specialized to work with the Unordered Sequential system, the Ordered Sequential system, and the Struck system. Other templates can be defined by the user, added as needed, and saved for later reuse. Templates are further modifiable to fit the needs of a particular court action or the preferences of a particular judge.

Once a template is selected, the user, either manually or through a series of prompt screens, enters the pertinent initial setup information. This setup information includes the number of litigants, the size of the jury, the number of alternates, whether jurors are screened individually or in groups, the sequence by which jurors are questioned, the allowed number of peremptory challenges available to each litigant, the sequence by which jurors are challenged, and the statistical characteristics of the jury pool. Templates containing such information and data can be saved to a database and retrieved for future actions. Multiple networked users may simultaneously view and modify such saved information in near-real time.

Juror Ratings: Knowledge of the backgrounds and attitudes of potential jurors and their possible replacements, gained from the voir dire examination, is used to rate potential jurors and replacements. Such ratings can be made by counsel or professional jury consultants who specialize in jury selection. Ratings may be multidimensional such that jurors are rated on a multiplicity of scales. The present invention provides a method for allowing the user to enter and store ratings for each potential juror on one or more rating scales. Such ratings may be modified any time new information becomes available, for example, after voir dire. Ratings can be entered as numeric values, value ranges or rating probability distributions. The choice of scale type depends on the degree of certainty a user has regarding the juror rating and the amount of information available regarding specific jurors, replacements and the jury pool as a whole. Ratings can be made on one or on multiple rating scales. Ratings from multiple scales can be combined according to a user-defined formula in order to provide a single overall rating for each potential juror. We shall refer to the combined rating of the i^{th} juror for party p as R_{p,i}. When there is no danger of ambiguity, we shall suppress the subscript p.

The current invention determines the optimal exercise of challenges for the user based upon ratings of jurors and juror replacements entered by the user for all parties to the litigation. The current invention uses a user-specified formula to determine a value for a seated jury, based on the ratings entered for each individual juror comprising the jury.

Rating Scales: The current invention provides a method to define one or more juror rating scales. If multiple scales are defined, a method is further provided to combine such scales into a single overall rating according to a user provided formula.

Multiple Agents: A given litigant may be represented by one or more agents including one or more lawyers and trial consultants. Each such agent may have a separate opinion regarding the rating to be assigned to each juror. The current invention allows each such agent to separately enter their desired rating, therefore circumventing the need for hurried courtroom negotiations between agents. Agent ratings are combined by the current invention to produce an overall rating distribution for each juror which reflects the ratings assigned by each separate agent.

Jury Pool Ratings: Each party in an action may define a statistical distribution of juror ratings which characterizes the jury pool as a whole. Such a distribution may be obtained by lawyers or their consultants through population surveys, mock trials, past experience, or other means. The distribution of juror ratings may be multivariate, if multiple rating scales have been defined. The current invention provides a method for entering, storing, viewing and modifying a univariate or multivariate jury pool rating distribution. A preferred embodiment uses one or more range sliders for each rating scale, displayed on a computer-based UI, to enter, view and modify rating parameters that describe the jury pool rating distribution. The rating distribution parameters are stored in a database on a local computer or on a networked server. We shall refer to the rating distribution function for a population of jurors as P(R).

Opposing Party Ratings: The current invention makes use of the opposing party's juror ratings in order to predict the opposing party's peremptory challenges and their actions in response to the current party's challenges. The opposing party's juror ratings may depend on the opposing counsel's theory of defense (or prosecution), personal preferences or ‘hunches’ which may not be well known by the current party. The current party can make a best estimate as to the opposing party's juror preferences and may update this estimate as more information is known, for example, based upon opposing party's voir dire questioning and/or prior juror challenges. The opposing parties generally have opposing interests in the value of the final jury. For example, when the juror ratings specify probability of conviction, the prosecution will desire to maximize the jury value while the defense will desire to minimize the jury value.

When little is known about an opposing party's juror ratings, it is reasonable to presume that the ratings (as defined above) of opposing parties are the same as those of the current user, leading to a so-called ‘zero-sum’ interaction. As new information is obtained about opposing party preferences, the estimated opposing party juror ratings can be adjusted for higher accuracy.

Multiple Litigants: Trials may involve two or more litigants, each with varying degrees of opposing or aligned interests. The current invention allows for juror ratings to be entered for any number of litigating parties, such ratings being accounted for when determining the probable challenge actions for all parties. When a party's interests are in alignment with the party using the current invention, the current invention allows for cooperation between the aligned parties through aggregation of said aligned party's available challenges and coordination of challenge choices. This is especially important in preventing aligned parties from making redundant challenges and thereby wasting available challenges.

Rating Uncertainty and Rating Distributions: Juror ratings may include a degree of uncertainty. Even after a detailed examination, a litigant may uncertain about the degree of favorability of a particular juror. Each potential juror therefore is allowed by the current invention to have a range or distribution of favorability rating. The less certain a litigant is about the favorability of a juror, the wider will be the range or rating distribution. A juror who has not yet been questioned may be rated on superficial information such as demographic information, demeanor, actions, or dress, and would likely have a higher degree of uncertainty compared with a juror who has undergone a complete voir dire examination. A juror who has undergone voir dire, but has given conflicting responses or has not been forthcoming or truthful, may also have a high degree of rating uncertainty. The current invention provides a method to enter, store, display, modify and share juror rating ranges and rating distributions reflecting rating uncertainties. Rating distributions for each juror are displayed and edited using numerical scales as well as graphical elements such as sliders, star lines or bar graphs. In addition, visual annotations such as color, border style, images or text style, are used to draw attention to representations of jurors based upon their ratings, in certain circumstances as described below. We refer to a rating probability distribution by party p for the i^{th} juror as P_{p,i}(R). When there is no danger of ambiguity, we shall suppress the subscript p.

Jury Value: A jury of size N is described by a set of N ratings or rating distributions. The value, V, of a given jury is given by a function, V, of individual juror ratings such that:

V=V(R₁,R₂, . . . R_{N}) Eq. 1

When the rating for the i^{th} juror is given as a rating probability distribution, Pᵢ(R), rather than a single numeric value, R, the expected jury value, V̅, can be calculated as an integral over this distribution:

V̅=∫V(R₋1,R)Pᵢ(R)dR Eq. 2

Here, R₋₁={R₁, R₂, . . . , Rᵢ₋₁, Rᵢ₊₁, . . . , R_{N}} represents the set of known juror ratings not including i^{th} juror. This equation can be further generalized when multiple juror rating distributions are given. When opposing parties have different rating sets, Equations 1 and 2 would use the appropriate rating set for the party in question. For example, the prosecution and defense in a two party action may rate jurors differently, leading to different jury values given the same set of jurors. When the rating, R, represents the probability of conviction, the jury value is given by the product of juror ratings: V=ΠᵢRᵢ. In Equations 1 and 2, the indices specifying the party in question have been suppressed.

The Peremptory Challenge Process: After the initial setup is completed, the peremptory challenge process begins. The details of the peremptory challenge process depend upon the system used in the particular courtroom. Common systems include Struck and Sequential. The Sequential system is further divided into Ordered Sequential and Unordered Sequential. Each such process is described below:

Struck system: The struck system allows for complete information to be obtained about all potential jurors prior to the exercise of any potential challenges. In this case, a number of potential jurors equal to the desired size of the jury (possibly including alternate jurors), plus the total number of allowed peremptory challenges is seated. Voir dire examination is then made by all parties and juror ratings are entered by the user of the current invention based upon the results of said examination. The current invention allows juror ratings to be entered on one or more scales and on each such scale entered as ranges which describe the confidence in the rating. When a litigant is represented by multiple agents, the current invention allows for separate rating entries by each such agent. Additionally, the current invention allows the user to optionally enter estimated ratings for the opposing party (or parties). When no such opposing party ratings are entered, the current invention assumes that said ratings are identical to the current party's ratings. Such a system ratings is called ‘zero sum’. When separate ratings for opposing parties are entered, the process is called ‘non-zero sum’.

Once all ratings have been entered, the current invention combines ratings on each scale entered by each agent into a single overall rating for each juror. When ratings are given as ranges or distributions, the current invention calculates the expectation value (average) of the resulting combined rating. The current invention then recommends to the user which jurors should be challenged in order to obtain the most favorable final jury.

In the zero sum Struck case, the present invention will recommend that the user challenge the least favorable jurors, equal in number to the number of challenges available to the user. When ratings represent probability of conviction, the prosecution will challenge the jurors with the lowest ratings and the defense will challenge jurors with the highest ratings. When ratings are entered as ranges or distributions, where multiple rating scales are defines and where multiple agents act rate jurors, the present invention aggregates and averages the ratings as described below to calculate a single combined rating for each juror.

The process used by the current invention to make challenge recommendation for a zero sum Struck system as follows:
1) The seated jurors are given ratings, rating ranges or rating distribution functions based on the results of voir dire examination or from other available observations. Such ratings are made on one or more rating scales and by one or more agents.

2) The ratings entered in step (1) are combined according to a specified scale combination formula.

3) The ratings entered in step (2) are combined according to a specified agent combination formula.

4) Opposing party ratings are calculated as the zero sum equivalents of the current party ratings.

5) The least favorable jurors equal in number to the number of available challenges are recommended for peremptory challenges.

The process used by the current invention to make challenge recommendation for a non-zero sum Struck system as follows:
1) The seated jurors are given ratings, rating ranges or rating distribution functions based on the results of voir dire examination or from other available observations. Such ratings are made on one or more rating scales and by one or more agents.
2) The ratings entered in step (1) are combined according to a specified scale combination formula.
3) The ratings entered in step (2) are combined according to a specified agent combination formula.
4) Estimated opposing party ratings are entered.
5) All possible pure strategies are determined for each party, each such pure strategy representing possible juror challenges.
6) A game matrix is constructed representing all possible pure strategy combinations (taking one pure strategy from each party) together with the jury value to the user for each such strategy combination. The jury value being determined from the combined juror ratings determined in steps (3) and (4).
7) An algorithm is applied to the game matrix to determine the user's optimal strategy or strategies—i.e., the Nash equilibria. The algorithm first eliminates all dominated strategies. Next, an open source or proprietary game solver is employed to determine optimal strategy or strategies from among the remaining non-dominated set.
8) If multiple optimal strategy exists, or if an optimal strategy is found to be a combination of pure strategies, the user is provided with a method to randomly select one such strategy from the multiplicity of resulting pure strategies.

### EXAMPLE 1

### A jury of twelve (12) members is to be selected. Both prosecution

(the user of the current invention) and defense (the opposing party) are afforded four (4) peremptory challenges. The prosecution is represented by a team of two attorneys and one trial consultant. Twenty (20) potential jurors are seated (12+4+4) and each has been examined by the prosecution and defense. Based on these examinations, each prosecution agent has assigned rating ranges to each potential juror for three separate rating scales. These ratings are entered into the current invention through the provided UI. The three rating scales are defined by the prosecution to be of equal weight, i.e., a juror's combined rating is the sum of its rating on each scale. The three agents are likewise given equal weight. The prosecution elects to use a zero sum process which therefore instructs the current invention to assign default ratings as an estimate for the ratings of the defense. The current invention then combines the rating scales for each juror and determines the expected (average) rating over the resulting range of combined ratings. The current invention then averages the combined ratings for the three prosecution agents to arrive at a single final rating for each juror. The four (4) jurors with the lowest such average final rating are highlighted on the UI indicating that the prosecution should challenge those highlighted jurors.

Sequential System: Sequential jury selection systems seat a number of jurors equal to the jury size (plus alternates) before any detailed juror examination is made. These seated jurors are then examined individually or in groups by the litigants, and after such examinations, challenges are optionally exercised on the seated jurors in order. When a juror is challenged, a replacement is selected either at random (Unordered Sequential System) or in order (Ordered Sequential System) from the jury pool. The replacement juror is subsequently examined and optionally challenged. When exercising a challenge, litigants have little if any information about the rating of the replacement juror. A decision to challenge a particular juror can be made solely on comparing the rating of a juror upon examination with the statistical distribution of ratings among the replacement jurors from from questionnaires, supplemental questionnaires, demographic studies, mock trials, previous experience, observations of demeanor, behavior, dress, etc.

Sequential systems differ both by how jurors are initially examined—individually or in groups—and how replacements are selected—randomly or in order from the jury pool. The current invention provides the most general Sequential System solution by allowing for rating distribution functions to be entered for each juror and replacement. In a system where replacements jurors are selected at random from the jury pool, the current invention uses the jury pool rating distribution function as an estimate of the replacement juror rating. When a replacement juror is selected and examined, a rating specific to that replacement juror is entered. When replacement jurors are ordered, the current invention allows for entering rating distribution functions specific to each juror prior to their examination. When a juror is examined, the distribution function for that juror is optionally modified to reflect any new information. The user of the current invention can adapt to any sequence of voir dire examination and juror replacement selection with a judicious choice and modification of juror rating distribution functions.

The process used by the current invention to make challenge recommendation for Sequential jury selection is:
1) A ‘game tree’ is generated as described below.
2) The seated and replacement jurors are given rating distribution functions based on the results of voir dire examination or from other available observations. For the Unordered Sequential system, unexamined jurors are rated according to the jury pool rating distribution. For the Ordered Sequential system, unexamined jurors are rated according to distributions associated with available information including demographics, behavior, demeanor, dress, etc.
3) Estimated opposing party ratings are entered for the seated and jurors, or optionally calculated by the current invention based on the user entered ratings entered in step 2.
4) The current decision point for the user is represented by the root node of the current game tree. The current invention recommends to challenge or accept the juror by selecting the more favorable of the two game tree child nodes, the values of which are calculated as described below.
5) The user's decision to exercise a challenge is entered into the current invention.
6) Any decision by opposing parties to exercise challenges are entered into the current invention.
7) If no further seats are available for consideration, or no further challenges remain, the jury selection process is completed. Otherwise, the game tree is pared to the current branch, and the process returns to Step 2, now including any new replacement jurors, excluding any challenged jurors, and with the new root node now being set to the child node selected in step 5.

Sequential System Game Tree Generation: A jury of N seats is considered according to the following selection process: Each seat is initially filled with a juror who has been examined and rated by all parties. Each seat is then considered in sequence and parties are allowed to exercise challenges against the seated juror, the parties moving in an order set by the court. If a challenge is exercised, the seated juror is excused and a replacement jurors is seated. The moving party then examines the replacement juror and optionally exercises another challenge. For the unordered Sequential system, replacement jurors are selected at random from the jury pool. For the Ordered Sequential system, jurors are selected in order from the pool. The process repeats until the moving party is satisfied. The next party in the order set by the court then undergoes the same process. When all parties are satisfied with the currently seated juror, the process repeats with the next jury seat. When all parties are satisfied with all seated jurors, or have exhausted all challenges, the process is complete.

We assume that there are a total of p parties involved in litigation. We define the set of parties, P, as

P={P₁,P₂, . . . ,Pₚ}.

For a typical action with parties consisting of prosecution and defense, p=2. We define a set representing the number of remaining challenges currently available to each party as:

c={C₁,C₂, . . . ,Cₚ}.

The set of jurors currently seated in the N available jury seats is given by:

J={J₁,J₂, . . . ,J_{N}}.

The set of M replacement jurors is given by:

K={K₁,K₂, . . . ,K_{M}}.

For the unordered system, the elements of K are considered to be random selections from the jury pool.

We define the state, S, of a given step in the jury selection process as

S=S(Pᵢ,C,J,K).

Here. Pᵢ represents the party in control of the node, i.e., the party currently making the choice to exercise a peremptory challenge.

We define a game tree Gⱼ, representing the game tree for the j^{th} jury seat. Each node in Gⱼ represents a given state, S. Assuming Cᵢ>0, the node will have two child nodes—one representing accepting the currently seated juror and one representing challenging the currently seated juror. If Cᵢ=0, only an accept child will exist. If all parties have accepted a juror, or if Cᵢ=0 for all i, the branch terminates in a leaf node. Each leaf node represents an outcome state for the selection process of the j^{th} jury seat. An example game tree for p=2, C₁=C₂=1 is shown in FIG. 2. In FIG. 2, circles represent decision points for Party 1. Squares represent decision points for Party 2. Arrows represent leaf nodes at which the game terminates. Each non-leaf node has a single child node representing accepting and a single child node representing challenging the current juror. The values in parentheses indicate the juror or replacement who would be seated if a given node is reached.

As described above, once all parties have made their challenge choices for a given jury seat, the juror selected for that seat has been settled and the process repeats for the next jury seat in sequence. The selection process for a given seat therefore results in a new game tree, beginning with the state, S, which is the outcome state for a leaf node reached in the previous game tree. Each leaf node in a given tree therefore becomes a root node for new tree representing the next seat. The structure terminates at the leaf nodes of the set of trees representing the N^{th} jury seat. We therefore write the complete game tree, Γ, as:

Γ=G₁×G₂× . . . ×G_{N},

where the ‘cross product’ of games is meant to specify that each leaf node of game Gᵢ becomes a root node for a new game Gᵢ₊₁ for all i<N. An example complete game tree for p=2, N=2, and C₁=C₂=1 is shown in FIG. 4.

Calculation of node values: When the user arrives at a node representing decision point regarding a particular juror, he must choose whether to accept or challenge the juror. If the juror is accepted, and an opposing party has not exhausted its challenges, the opposing party can then choose to either accept or reject the juror. For clarity, we first assume an action involving two parties: prosecution and defense (or plaintiff and defendant). We further assume that the ratings, R, represent probability of conviction (or of finding for the plaintiff). In this case, the prosecution (or plaintiff) wishes to maximize the value of the jury and the defense (or defendant) wishes to minimize the value of the jury. This situation is shown by the sub-tree shown in FIG. 3. The expected value of a node representing the i^{th} juror, before examination of this juror, is therefore determined by the following integral over the juror's rating distribution:

V̅ⱼ=∫₀^{R}* V̅_{pc}Pᵢ(R)dR+∫_{R}_{_{*}}^{R}*Vⱼ(R)Pᵢ(R)dR+∫_{R}_{_{*}}¹ V̅_{dc}Pᵢ(R)dR, Eq. 3

Where Pᵢ(R) is the rating distribution for the juror under consideration. When multiple rating scales have been defined and when multiple agents represent a litigant, the rating distribution, Pᵢ(R) is the distribution resulting from combining said scales and agents as described above. The child node values V̅_{pc} and V̅_{dc} are the values of the child nodes resulting from a challenge by the prosecution and a challenge by the defense, respectively, and the two threshold ratings are given by:

R_{*}=R:Vₚ(R)= V̅_{pc}

and

R*=R:V_{d}(R)= V̅_{dC}.

The subscript, j, refers to the party in control of the node (e.g., prosecution or defense) and the subscript, i, refers to the index of the juror under consideration. The distribution Vⱼ(R) is the value to party j of accepting juror i.

Equation 3 defines the value of a node, Vⱼ, recursively in terms of child nodes V_{pc} and V_{dc}. In the case that the prosecution has exhausted all challenges, we set R_{*}=0. When the defense has exhausted all challenges, we set R*=1. When more than one opposing party is involved, R* (or R_{*}) is taken to be the lowest (or highest) from among the set of R* values for the multiple opposing parties.

For the Ordered Sequential system, the rating distribution, Pᵢ(R), represents the rating distribution for the i^{th} replacement juror. For the Unordered Sequential system, the rating distribution Pᵢ(R)=P(R), the rating distribution for the jury pool as a whole.

### EXAMPLE 2

We consider a two party action with prosecution and defense as party 1 and 2, respectively. A Jury of 1 member is to be selected using the Sequential system. The prosecution has a single challenge while the defense has none. Both prosecution and defense have identical juror ratings. The situation is described by the game tree shown in FIG. 1a. The replacement juror rating, R, is described by the uniform rating distribution:

$$P ( R ) = \{ \begin{matrix}1 , & 0 \leq R < 1 \\ 0 , & otherwise\end{matrix}$$

In this case, V̅_{pc}=0.5, R_{*}=0.5. If, upon examination, the current juror is found to have a rating lower than R_{*}, the juror will be challenged, otherwise, the juror will be accepted. The expected value of the root node before examination of juror J₁ will be:

V̅ₚ=0.5×2×∫₀^{0.5}dR+2×∫₀₅¹RdR=5/8

### EXAMPLE 3

We consider the same situation as in Example 2, but with the defense having a single challenge and the prosecution having none. The game tree is shown in FIG. 1b. In this case: V̅_{dc}=0.5, R*=0.5. If, upon examination, the current juror is found to have a rating higher than R*, the juror will be challenged, otherwise, the juror will be accepted. Before examination, the expected value of the root node will be:

V̅_{d}=∫₀^{0.5}RdR+0.5×∫_{0.5}¹dR=3/8

### EXAMPLE 4

We consider the same situation as in Example 2, but with the prosecution and defense each having a single challenge. The current juror and both replacement jurors have the uniform rating distribution as given in Example 2. The game tree is shown in FIG. 2. The relevant portions of the reduced game tree, having evaluated lower nodes according to the Examples 2 and 3, is shown in FIG. 3. Using the results of Examples 2 and 3, we find: V̅_{pc}=3/8, V̅_{dc}=5/8, R_{*}=3/8, and R*=5/8. If, upon examination, the current juror is found to have a rating lower than R_{*,} the juror will be challenged by the prosecution. If the juror is found to have a rating higher than R*, the juror will be challenged by the defense. Otherwise, the juror will be accepted by both parties. Before examination of the current juror, the expected value of the root node will be:

$$\overline{V} = \frac{3}{8} \times {\int }_{0}^{3 \text{/} 8} d R + {\int }_{3 \text{/} 8}^{5 \text{/} 8} R d R + \frac{5}{8} \times {\int }_{5 \text{/} 8}^{1} d R = 0.5 .$$

### EXAMPLE 5

We consider a two party action with prosecution and defense as party 1 and 2, respectively. A Jury of 2 members is to be selected using the Ordered Sequential system. The prosecution and defense each have a single challenge. Both prosecution and defense have identical juror ratings. The prosecution is the first to optionally exercise a challenge. The situation is described by the game tree shown in FIG. 4. All jurors are described by the uniform rating distribution:

$$P ( R ) = \{ \begin{matrix}1 , & 0 \leq R < 1 \\ 0 , & otherwise\end{matrix}$$

The overall jury rating is the product of the ratings of the two jurors.

We now determine under what conditions the prosecution should challenge the first juror, J₁. Using the results of Examples 2, 3, and 4, we may reduce the game tree to that of FIG. 5. From this game tree, we calculate:

$${R}_{*} = 2 \times \frac{3}{8} \times \frac{3}{8} = 0.28125$$

$$and$$

$${R}^{*} = 2 \times \frac{5}{8} \times \frac{5}{8} = 0.78125 .$$

Juror 1 will be challenged by the prosecution, if upon examination, Juror 1 is found to have a rating less than R_{*}=0.28125. Before examination of Juror 1, using Equation 4, we find the expected value of the jury is:

$$\overline{V} = \frac{3}{8} \times \frac{3}{8} \times 0.28125 + \frac{1}{2} \times \frac{1}{2} \times ( {0.78125}^{2} - {0.28125}^{2} ) + \frac{5}{8} \times \frac{5}{8} \times ( 1 - 0.78125 ) = 0.258$$

### BRIEF DESCRIPTION OF DRAWINGS

FIG. 1. A Game Tree representing the case where a single juror is to be chosen. One party has a single challenge available while the opposing party has no available challenges. The root node represents the current juror. The leaf nodes, V_{pc} and V_{dc}, represent the expected value of challenging the current juror. The leaf nodes, V(J), represent the value of accepting the current juror.

FIG. 2. A complete game tree representing the case where a single juror is to be selected and both prosecution and defense have a single challenge.

FIG. 3. A portion of a game tree representing the case where a single juror is to be selected and both prosecution and defense have a single available challenge.

FIG. 4. A game tree representing a two-seat jury a where both prosecution and defense have a single available challenge.

FIG. 5. A reduced Game Tree for the situation described in FIG. 4, wherein lower level nodes have been evaluated.

FIG. 6. Flow diagram representing the process of a preferred embodiment.

FIG. 7. Detail of the Game Theory Engine process.

FIG. 8. Detail of the Game Tree Generator process.

FIG. 9. Detail of the Node Evaluator process.

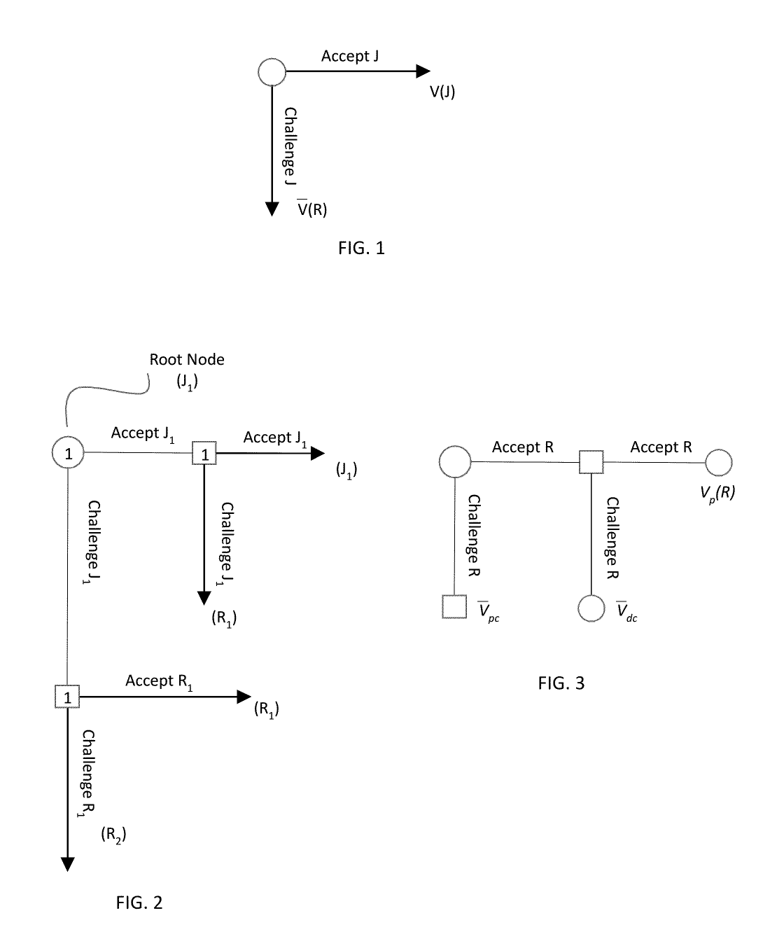

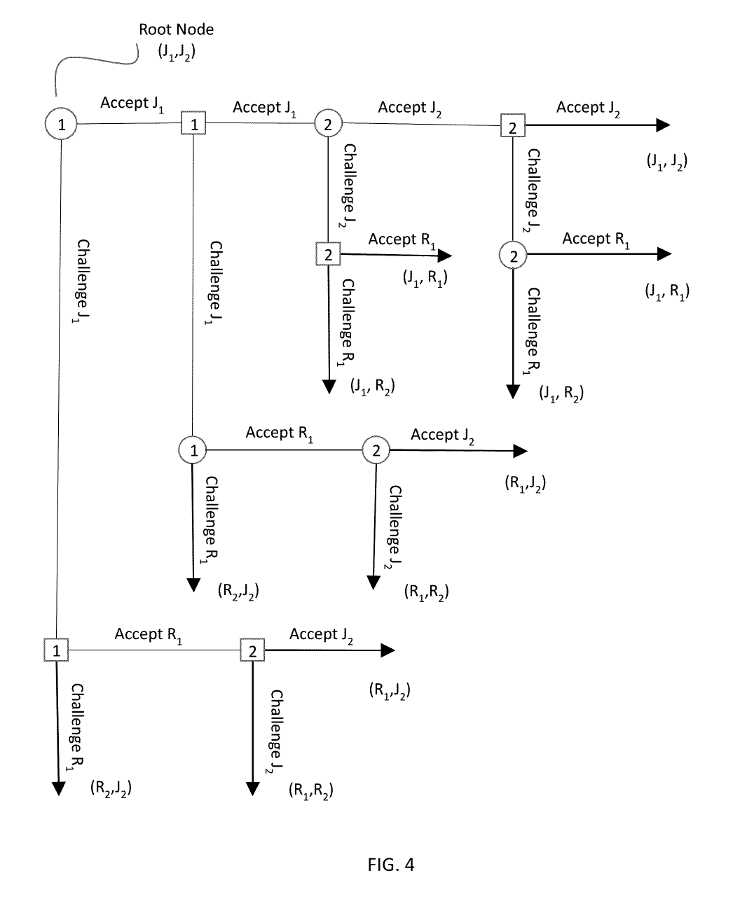

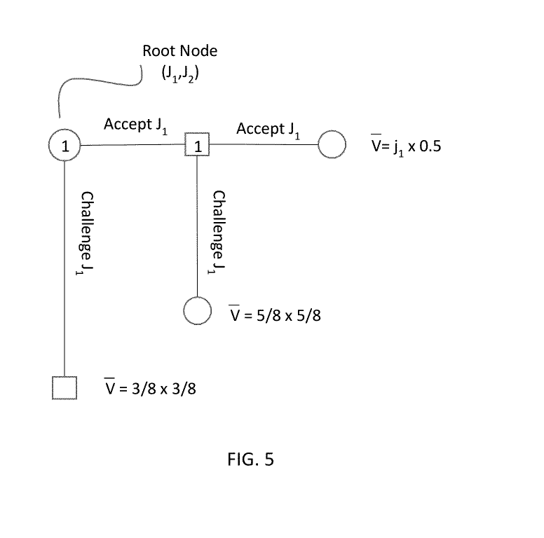

### DETAILED DESCRIPTION OF A PREFERRED EMBODIMENT

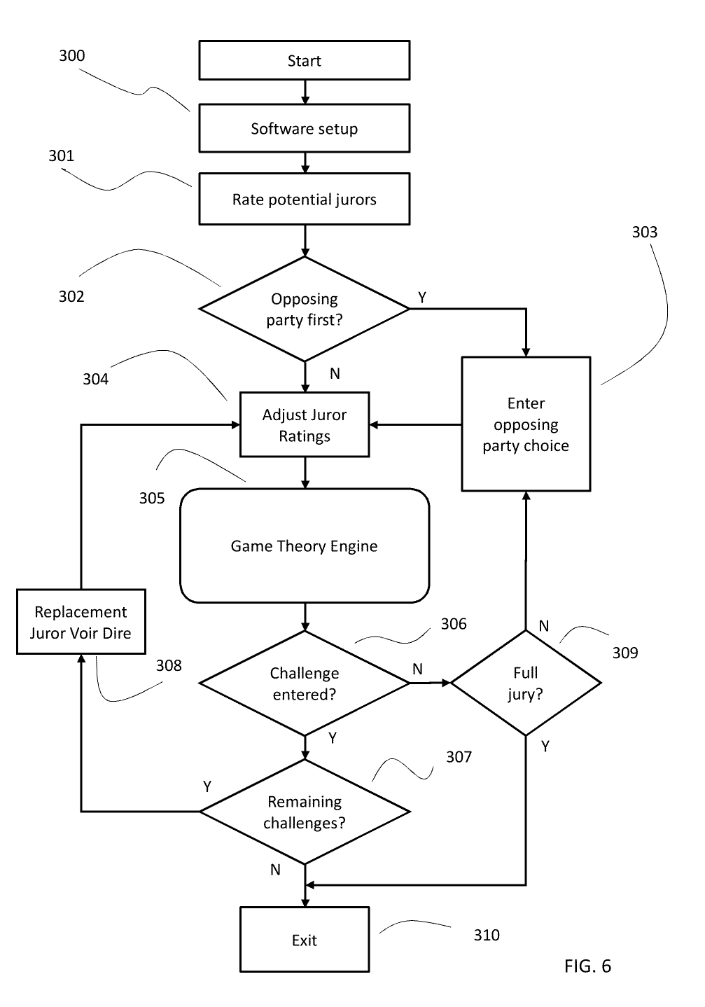

FIG. 6 represents the components that comprise the current invention. The invention includes a user interface that allows the user to enter information about the jury selection process, to define and enter juror ratings, to view software recommendations regarding the exercise of peremptory challenges, and to record challenges made by the user and by the opposing party or parties. A Game Theory Engine makes recommendations to the user regarding the choice of whether and when to exercise a peremptory challenge. When a challenge is exercised, either by the user or by an opposing party, the user enters this information into the UI to be stored locally or on a networked database for later use by the Game Theory Engine. The user optionally updates juror ratings based on new voir dire examination or other new information obtained during the selection process. The Game Theory Engine updates subsequent recommendations based on this updated information. This process continues until the complete jury has been empanelled.

Software setup module 300 represents a set of user interface (UI) elements that allow for entering information about the present action including case number, title, names of litigants, names of opposing counsel, and court jurisdiction. In addition, UI elements are provided for entering the general parameters of the selection process, including the selection process type (Sequential or Struck), the rule for alternating selections between parties, the number of peremptory challenges available to each party, the number of jurors to be seated, the number of alternate jurors to be seated, the number and type of juror rating scales used, and, if multiple scales and multiple agents are used, the user's formula for combining such scales and agents into a single overall rating, rating range or rating distribution for each juror.

Juror rating module 301 represents a set of UI elements representing each potential juror, alternate juror, juror replacement and jury pool. These elements include an icon or image of a potential juror, identifying information such a juror name and/or number, and a set of sliding or selectable scales for entering and modifying juror ratings. Provisions are made for entering ratings for the litigant using the current invention and for entering best estimate ratings for the opposing party. Optionally, opposing party ratings can be set automatically by the software to be calculated from the ratings made by the current party. Ratings can be entered using UI elements such as numeric sliders, range sliders, select lists, numeric up-down elements, check boxes, radio buttons, or star groups. Ratings can be specified as ranges or distributions, using, for example, a dual slider or a user-controllable histogram, to allow the user to specify a degree of uncertainty in the rating.

Decision point 302 represents a process that determines, based on initial setup information or by user input, which party is the first to be given a choice to exercise a challenge. If an opposing party moves first, then control is passed to item 303. If the current party moves first, control is passed to the secondary juror rating module 304. In subsequent iterations through the current process, parties alternate challenges according to a rule specified in the initial setup process as described above.

If item 303 is reached, the opposing party makes their decision to challenge a juror. If such a challenge is exercised in a Sequential System, a replacement juror is seated. If a challenge in exercised in a Struck System, the challenged juror is excused. When the opposing party is satisfied with a juror, control passes to the secondary juror rating module 304 which allows the current party to optionally adjust juror rankings based upon any new information obtained during execution of the process of item 303, which may have included additional voir dire examination.

Control is next passed to the Game Theory Engine 305 which is described in greater detail below. The Game Theory Engine 305 functions to make recommendations to the user regarding the exercise of their next juror challenge.

Once a challenge recommendation is made by 305, control is passed to item 306 which allows the user to either their challenge choice regarding the present juror. If a challenge is entered, control is passed to decision point 307 which tests for remaining challenges. If the current party has exhausted their available challenges, the process ends. Otherwise, control is passed to item 308 where, when using a Sequential system, a replacement juror is examined. When using the struck system, 308 has no effect. Control is then passed back to the juror rating module 304 and the process repeats. If no challenge is entered in decision point 306, the process determines whether a full jury has been seated at decision point 309. If so, the process exits at item 310. If the jury is not full, control is passed back to the opposing party in item 303. This process repeats until either a full jury is seated or the current party has exhausted its available peremptory challenges.

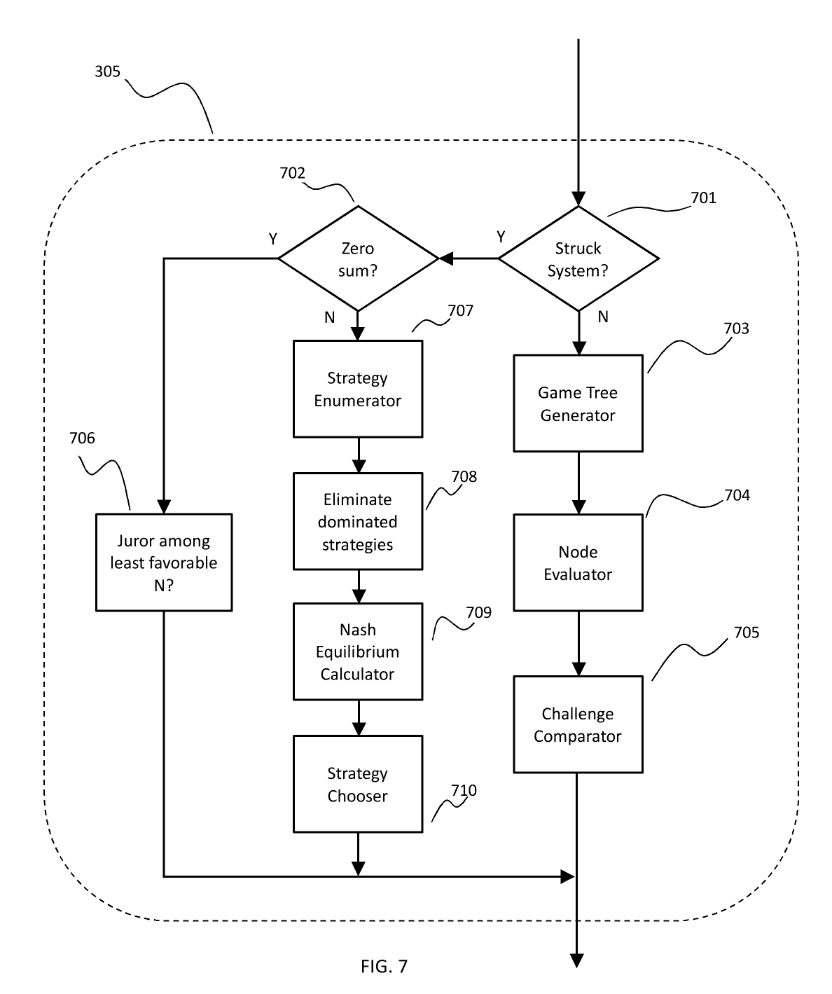

Detail of the Game Theory Engine (GTE) process 305 is shown in FIG. 7. The function of the Game Theory Engine depends on the jury selection system in use in the current courtroom, as specified during the initial setup process. Decision point 701 determines which selection system is in use. In the case of Struck system, control passes to decision point 702. For a zero sum struck system 702 passes control to 706 where, when the user is provided with N challenges, the least favorable N jurors are selected for challenges. For the prosecution, these will be the N jurors rated with the lowest probability of conviction. For the defense, these will be the N jurors rated with the highest probability of prosecution. Process 702 combines ratings from multiple scales and multiple agents into a single rating, and determines whether the current juror is among the N least favorable among said combined ratings. If so, 706 recommends that the juror be challenged. When juror ratings are given as ranges or distributions, the expectation value (average) of this range is used compare the favorability of jurors.

In the case of the Non-Zero Sum Struck system, control passes to the Strategy Enumerator 707 which enumerates all possible pure strategies for juror challenges. A pure strategy can be thought of as a set of rules to apply against a set of jurors. An example of a pure strategy would be challenge juror 3 from a panel of 12 jurors, and don't challenge any other jurors. Pure strategies can be represented as an array of such instructions. For example the previously mentioned pure strategy could be written as an array:

S₃=[0,0,1,0,0,0,0,0,0,0,0,0]

Where array items represent jurors, and ‘0’ means don't challenge and ‘1’ means challenge the respective juror. For two litigants selecting a jury with N members, and where Party 1 has C₁ peremptory challenges and Party 2 has C₂ peremptory challenges, there would N_{TOT}=N+C₁+C₂ potential jurors to be examined. The total number of pure strategies, Nᵢ, for Party i is then given by:

$${N}_{i} = {\sum }_{n = 0}^{{C}_{i}} ( \begin{matrix}{N}_{TOT} \\ n\end{matrix} )$$

Here the parentheses signify the mathematical operation of choosing n objects from a total of N objects:

$$( \begin{matrix}N \\ n\end{matrix} ) = \frac{N !}{n ! ( N - n ) !}$$

and Σ represents a standard summation. Strategies for actions with three or more parties can be found as a straightforward generalization of the above. At any given step in the jury selection process described by FIG. 6, the Strategy Enumerator, item 707, calculates all possible pure strategies available to each party. When all strategies have been enumerated for all parties, dominated strategies are eliminated by item 708.

The Nash Equilibrium Calculator 709 forms a game matrix based upon the ratings for all outcomes from all possible non-dominated strategy combinations, one taken from each party. The Nash equilibrium is then calculated using Quadratic Programming or other well-known strategic form game solving algorithms. Proprietary or open source game solvers such as GAMBIT can be employed to calculate the Nash equilibrium solution. Strategy chooser 710 evaluates the optimal solution(s) calculated by the Nash Equilibrium Calculator 709. When a single solution is provided, 710 it is passed as output from the GTE 305. When more than one Nash equilibrium is found, or if the Nash equilibrium is a probability distribution over pure strategies, 710 uses a selection algorithm to select one pure strategy, based on selecting a pure strategy at random according to the probability distribution obtained from 709. The selected pure strategy is then passed as output from the GTE 305.

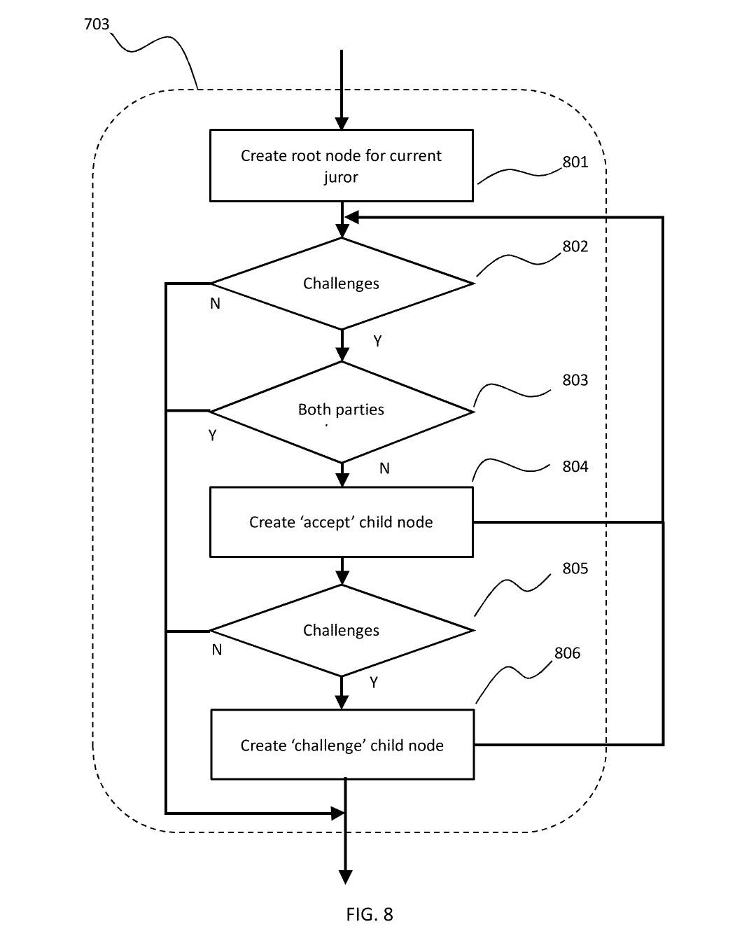

In the case of the Sequential systems, decision point 701 passes control to the Game Tree Generator 603, which is explained in more detail in FIG. 8. The Game Tree Generator 603 constructs a game tree representing all possible challenge choices made by the litigating parties. Control then passes to the Node Evaluator 604 and then the Challenge Comparator 605, each described in detail below.

FIG. 8 represents the Game Tree Generator 703. A root node is created by item 801 which corresponds to the current state comprised of the controlling party, the current seat, the set of seated and replacement jurors. Decision point 802 tests whether any challenges remain. If no challenges remain, then the process ends. If challenges remain, decision point 803 tests whether both parties have already accepted the current juror, if so, then the process ends. If not, then a child ‘accept’ node is created under the root node representing accepting the current juror by node creator 804. Decision point 805 tests whether the current party has any remaining challenges. If the current party has no remaining challenges, the process ends. If the current party has remaining challenges, a child ‘challenge’ node is created by node creator 806 representing a replacement juror. Both the accept node created by 804 and any challenge node created by 806 are recursively entered into process step 801 as new root nodes, thereby generating subsequent new child accept and challenge nodes. The recursive process ends when all challenges have been exhausted and the Game Tree is complete.

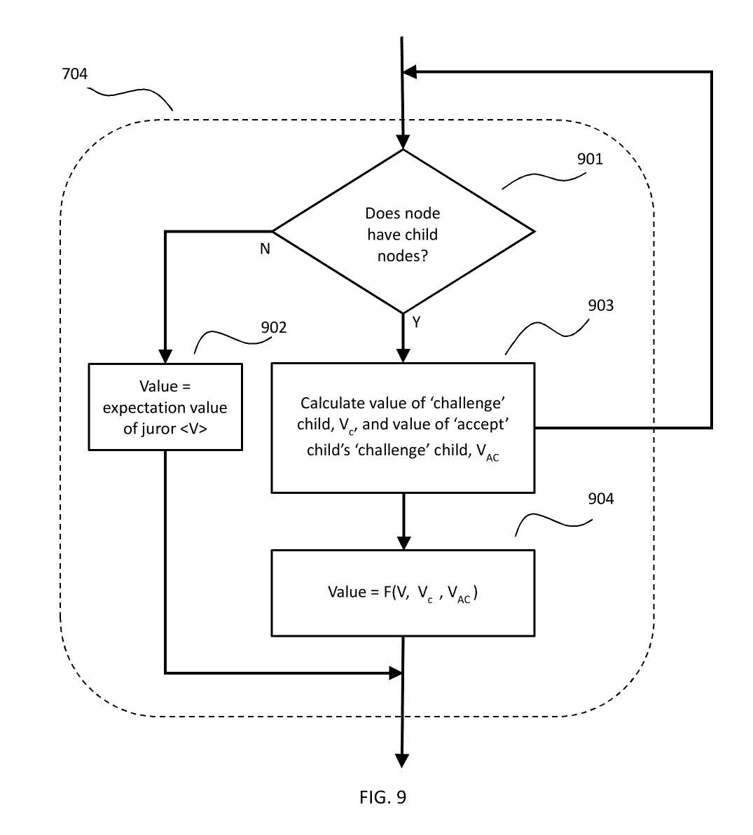

FIG. 9 represents the Node Evaluator process 704. A node is entered as input into the Node Evaluator 704. Decision point 901 tests whether this node has child nodes. If not, then the value is calculated by item 902 as the numeric rating value, the average of the rating range, or the expectation value of the rating probability distribution represented by the node, the choice depending on the type of rating used. For Order Sequential Systems, this rating value, rating range, or rating distribution is that of the juror or replacement juror represented by the node. For Unordered Sequential Systems, this rating value, rating range, or rating distribution is that of the juror represented by the node, or that of the jury pool if the node represents a juror selected at random from the jury pool. If the node is determined by 901 to have child nodes, then the values of these child nodes are determined recursively by entering each such child node into a new instance of a Node Evaluator process 704. When the values of these child nodes are determined, the value of the original node is calculated by 904 as a function of the current juror value and the value of said child nodes according to Equation 3.

The Challenge Comparator 705 determines what action to recommend to the user based on the node values calculated by Node Evaluator 704. For a node representing a juror under consideration, if the value of accepting the juror is lower than the value of the ‘challenge’ child, then challenge of the current juror is recommended. Otherwise, accepting the juror is recommended. This recommendation is displayed to the user on the UI component representing the current juror using techniques such as color highlighting, altered background color, a pointer image, bold text, or border highlighting. The process then proceeds to decision point 306 which allows the user to enter his challenge decision for display and later use by Game Theory Engine 305. The process repeats with item 304 now accounting for any new replacement jurors and optionally updated juror ratings. When no further peremptory challenges are available to the user, the process exits at item 310, with the UI showing the results of the fully empaneled jury.

While the invention has been described with reference to specific embodiments, modifications and variations of the invention may be constructed without departing from the scope of the invention, which is defined in the claims.

What is claimed is:

1. A process enabling one or more parties to a litigation to optimize the use of peremptory challenges against jurors from a panel containing a plurality of potential jurors, the process comprising the steps of:
a. Specifying the rules and procedures for jury selection.
b. Assigning ratings to at least one of the set comprised of jurors, alternate jurors, replacement jurors and the jury pool.
c. Estimating ratings assigned by one or more opposing parties for at least one of the set comprised of jurors, alternate jurors, replacement jurors and the jury pool.
d. Calculating the optimal use of peremptory challenges in order to obtain the most favorable jury empanelment for the user.
e. Making recommendations to the user to exercise peremptory challenges against one or more jurors, alternate jurors, or replacement jurors.

2. A process according to claim 1 further including the steps of
Entering and tracking peremptory challenges exercised by the user and all other parties to the litigation
Updating at least one of the set of juror, alternate juror, and replacement juror ratings based on new information gained during execution of the above process.

3. A process according to claim 1 wherein step (b) further includes juror ratings defined as rank values on an ordinal scale, as numeric values, as ranges of numeric values, or as probability distributions.

4. A process according to claim 1 wherein (b), further includes ratings on a multiplicity of scales, the rating scales being aggregated according to a user defined function to result in a single combined rating for each juror.

5. A process according to claim 1 wherein (b), further includes ratings by a multiplicity of agents, the agents' ratings being aggregated according to a user defined function to result in a single combined rating for each juror.

6. A process according to claim 1 whereby step (e) further includes peremptory challenge recommendations based on the application of Game Theory.

7. A process according to claim 1, whereby step (e) further includes the steps of:
Construction of a Game Tree with nodes representing possible jurors and edges representing peremptory challenge choices.
Calculation of the node values based on juror ratings, rating ranges, rating distributions or the rating distribution of the jury pool by recursively solving the equation:
V̅ⱼ=∫₀^{R}* V̅_{pc}Pᵢ(R)dR+∫_{R}_{_{*}}^{R}*Vⱼ(R)Pᵢ(R)dR+∫_{R}_{_{*}}¹ V̅_{dc}Pᵢ(R)dR,

8. A process according to claim 1, whereby step (e) further includes the steps of:
Enumerating all pure strategies representing all possible peremptory challenge choices by all parties.
Constructing a Game Matrix representing all possible combinations of pure strategies.
Calculating the Nash equilibrium(s) of the Game Matrix to determine the optimal strategy or strategy combinations.

9. A process according to claim 1, whereby step (e) further includes the step of:
Calculating the expectation value of each juror's aggregated ratings
Determining the least favorable jurors equal in number to the number of peremptory challenges allotted to the user based on said expectation value.

10. A process according to claim 1 whereby steps (b) through (e) are repeated sequentially after examination of each juror or subgroup of jurors, until a full jury has been empaneled,

11. A process according to claim 1 wherein challenged jurors are replaced from at least one of the set comprising an ordered group of replacement jurors and a random member of the jury pool.

12. A computer-readable medium storing, in executable form, computer code for causing a computer to perform methods for determining optimal peremptory juror challenge strategies, comprising:
a. A user interface operable to enter, view, save, retrieve, modify and share data related to a jury selection process.
b. A user interface operable to define one or more juror rating scales.
c. A user interface operable to enter juror ratings on one or more scales by one or more agents.
d. A user interface operable to define a method to aggregate a multiplicity of juror rating scales into a single overall rating.
e. A software code sequence comprising a Game Matrix generator.
f. A software code sequence comprising a Game Tree generator.
g. A software code sequence comprising a Game Theory Engine operable to solve a Game Matrix or Game Tree.
h. A user interface operable to display the results of peremptory challenge recommendation calculations made by said Game Theory Engine and associated processes.
i. A user interface operable to enter, view, save, retrieve, modify and share the results of juror challenges by all parties to an action.

13. A computer software product according to claim 12 further including a code sequence operable to rate jurors and the jury pool according to one or more ordinal rating scales, nominal rating scales, rating ranges, probability distributions, or combinations thereof.

14. A computer software product according to claim 12 wherein (c) allows separate agents to operate on separate networked computing devices, the data entries for each agent being combined according to a user specified formula and viewable by all agents in near-real time.

15. A computer software product according to claim 12 further including code sequences operable to calculate optimal peremptory challenge strategies for a one or any combination of jury selection systems from the set comprised of: Struck, Unordered Sequential, Ordered Sequential.

16. A computer software product according to claim 12 further including a code sequence operable to create, view, modify, save and share templates describing the rules of a jury selection system.

17. A computer software product according to claim 12 further including a code sequence operable to enter, modify, view, save and load from a saved data any state of the jury selection process.

18. A computer software product according to claim 17 where the state of the jury selection process is saved to a database.

19. A computer software product according to claim 18 where one or more networked computers can access and load data stored in a database on a networked server.

20. A computer software product according to claim 12 where the data can be entered, shared, saved, modified and viewed by a single or a multiplicity of networked users in near-real time.
